(19) United States
(12) Patent Application Publication
(10) Pub. No.: US 2024/0115368 A1
(43) Pub. Date: Apr. 11, 2024

(54) DEVICE FOR PULSED LIQUID DISPENSING, AND USE THEREOF

(71) Applicant: Milchhof Reeßum KG, Reeßum (DE)

(72) Inventor: Frank CORDES, Reeßum (DE)

(73) Assignee: Milchhof Reeßum KG, Reeßum (DE)

(21) Appl. No.: 18/275,987

(22) PCT Filed: Feb. 4, 2022
(86) PCT No.: PCT/DE2022/000010

§ 371 Date: Nov. 3, 2023

(30) Foreign Application Priority Data
Feb. 5, 2021 (DE) 10 2021 000 591.0

(51) Int. Cl. A61D 7/00; F04B 43/02; F04B 43/06

(52) U.S. Cl. CPC A61D 7/00; F04B 43/025; F04B 43/06

(57) ABSTRACT

A device for pulsed liquid dispensing includes a feed line, a dispensing unit, and a conveying device. The dispensing unit has a rigid lance with a dispensing tube. The feed line is connected to an input side of the conveying device. An outlet connection of the conveying device is connected to the output unit. The dispensing unit includes a gripping part and a manually actuated release valve. The conveying device is a diaphragm pump, so that, once the release valve is open, the number of pump cycles correlates with the volume of dispensed liquid. This allows a predetermined amount of liquid to be conveyed without distracting the operator.

### CROSS-REFERENCE TO RELATED APPLICATION

This application is a national stage application, filed under 35 U.S.C. § 371, of International Patent Application PCT/DE2022/000010, filed on Feb. 4, 2022, which claims the benefit of German Patent Application DE 10 2021 000 591.0, filed on Feb. 5, 2021.

### BACKGROUND

DE 200 18 682 U1 describes a device with which a granular base material is slurried by means of a liquid flow conveyed by a pump. This material is conveyed into the stomach of a farm animal in a plurality of partial jets. Conveying a predetermined volume is not possible with this device.

### SUMMARY

The disclosure relates to a device for pulsed liquid dispensing comprising a feed line, a dispensing unit and a conveying device. The dispensing unit has a rigid lance with a dispensing tube. The disclosure also relates to the use of this device for pulsed liquid dispensing.

The present disclosure is based on the problem of conveying a predetermined amount of liquid without distracting the operator.

This problem is solved with the features as disclosed and claimed. For this purpose, the feed line is connected to an input side of the conveying device. An outlet connection of the conveying device is connected to the output unit. The dispensing unit comprises a gripping part and a manually actuated release valve. The conveying device is a diaphragm pump, so that, once the release valve is open, the number of pump cycles correlates with the volume of dispensed liquid.

To operate the device, the diaphragm pump is connected to an energy source or to an energy reservoir. When the diaphragm pump is running, the release valve is open. This release valve is closed after completion of a specified number of pump cycles of the diaphragm pump.

The pumping of a liquid is effected by means of a diaphragm pump. Such diaphragm pump is a positive displacement pump, whose conveying flow only starts when a release valve opens. The conveying flow is designed to be pulsed, so that the volume of liquid is dispensed from the dispensing unit in individual bursts of equal volume. To reach a predetermined volume of liquid, the release valve is manually or automatically blocked after a corresponding number of pulses.

Further details of the invention are given in the subclaims and the following description of schematically illustrated embodiments.

### BRIEF DESCRIPTION OF THE DRAWINGS

FIG. 1: Device for pulsed liquid dispensing.

### DETAILED DESCRIPTION

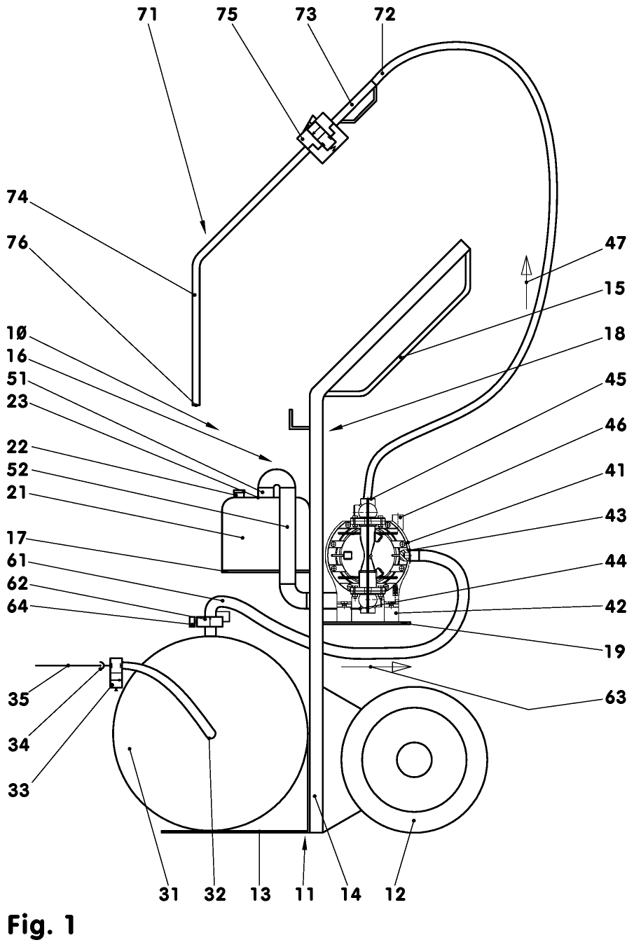

FIG. 1 shows a device (10) for the low-pressure dispensing of a small volume of a liquid. Such devices (10) are used to transfer a defined amount of liquid. Thereby, the device (10) is used, for example, to feed liquid to farm animals or to remove liquid from farm animals.

The device (10) shown in FIG. 1 comprises a transport carriage (11). In the exemplary embodiment, such transport carriage (11) is a hand truck (11). Such hand truck (11) has two wheels (12), which are arranged, for example, tangentially to a base mounting plate (13). A gripping linkage (14) projects between the base mounting plate (13) and the wheels (12). At the upper end of the gripping linkage (14), there are two gripping pieces (15) oriented in the direction of the wheels (12). The transport carriage (11) can also be designed as a three-wheeled or four-wheeled carriage. For example, it can comprise a coupling for hitching to a driven vehicle.

A support plate (17) is arranged on the gripping linkage (14) on the front side (16) of the hand truck (11) above the base mounting plate (13). Such support plate (17) is parallel to the base mounting plate (13). For example, it is half the size of the base mounting plate (13).

A pump plate (19) is fastened to the rear side (18) of the gripping linkage (14) above the wheels (12). For example, at the gripping linkage (14), the height difference of the pump plate (19) to the base mounting plate (13) is half the height difference of the support plate (17) to the base mounting plate (13).

A tank container (21) is located on the support plate (17). Such tank container (21) is securely fastened to the support plate (17) and/or to the gripping linkage (14). In the exemplary embodiment, the tank container (21) is a transparent canister (21), for example. It has a closure (22) at the top. In addition, in this exemplary embodiment, the tank container (21) has an extraction opening (23) at the top. The extraction opening (23) can also be arranged in the lower region or at the base of the tank container (21). In addition, a ventilation opening can be provided at the upper side of the tank container (21). This can be covered by means of a filter to protect against contamination. For example, such vent opening can be integrated into the closure (22).

In the exemplary embodiment, an energy reservoir (31) in the form of a compressed air reservoir (31) is located on the base mounting plate (13). The compressed air reservoir (31) is fastened to the hand truck (11), for example by means of tensioning straps. The compressed air reservoir (31) is, for example, a compressed air tank with a volume of 80 liters and a nominal pressure of 12.5 bar. For example, it is made of an austenitic steel. The diameter of the compressed air reservoir (31) is 400 millimeters, for example. Its length oriented in the transverse direction of the hand truck (11) is, for example, 750 millimeters. For example, the compressed air reservoir (31) has two threaded connections (32). Both threaded connections (32) are designed with internal threads M 22×1.5 on the reservoir side. In addition, the compressed air reservoir (31) has a drainage connection at the bottom.

On the inlet side, the compressed air reservoir (31) has, for example, a stopcock (33) and a quick coupling (34). A compressed air line (35) can be connected to such quick coupling (34) for filling the compressed air reservoir (31). This allows the compressed air reservoir (31) to be fed from a compressed air network. This provides a pressure of 10 bar, for example. If necessary, such feed line (35) can remain connected after the compressed air reservoir (31) has been filled. The compressed air reservoir (31) then operates in buffer mode. Instead of compressed air, the compressed air reservoir (31) can also be operated with nitrogen or another gas. It is also conceivable to arrange, for example, an electrically operated compressor on the compressed air reservoir (31) to increase the internal pressure of the compressed air reservoir (31).

The energy reservoir (31) can also be an electrical energy reservoir, depending on the structure of the device (10). For example, it is then designed as a battery or as an accumulator. However, the device (10) can also be connectable to an energy source, for example, pneumatic or electric. In such case, the energy reservoir (31) can be omitted if necessary.

A conveying device (41) is located on the pump plate (19). The conveying device (41) is a positive displacement pump in the form of a diaphragm pump (41). For example, it has four foot plates (42), which are bolted to the pump plate (19). The diaphragm pump (41) has at least one drive chamber and at least one media conveying chamber separated from the drive chamber by means of a diaphragm. The respective media conveying chamber is secured against backflow, for example by means of inlet-side and outlet-side check valves. During operation of the diaphragm pump (41), for example, the pressurization of the drive chamber displaces the diaphragm, wherein the media conveying chamber is compressed. In this process, the medium to be conveyed is pressed out of the media conveying chamber. When the pressure in the drive chamber is subsequently reduced, the diaphragm is displaced in the opposite direction, wherein the media conveying chamber is expanded for sucking in the medium to be conveyed.

The diaphragm pump (41) shown in FIG. 1 is designed as a double diaphragm pump (41). Such double diaphragm pump (41) has two working chambers and two media conveying chambers. For example, the two diaphragms are coupled together. They may also be driven individually. For example, a reversing valve controls the pressurization of the working chambers, so that they are alternatively pressurized with the drive medium, for example compressed air. The media is then conveyed alternatively by means of the first media conveying chamber and the second media conveying chamber. Thus, a complete stroke cycle of the double diaphragm pump comprises one double stroke. For example, the volume of liquid conveyed in a double stroke is 75 milliliters.

In the case of an electric drive of the diaphragm pump (41), for example, one piston is used in each case to drive a diaphragm. The operations in the respective media conveying chamber are carried out as described above.

The diaphragm pump (41) shown in FIG. 1 has, for example, a stand space of 180 millimeters by 200 millimeters. For example, its overall height is 250 millimeters. In the exemplary embodiment, the diaphragm pump (41) has a mass of 3.5 kilograms. The compressed air connection (43) is designed as a ½-inch connection, for example. For example, the inlet connection (44) and the outlet connection (45) of the medium to be conveyed have the same diameter. The maximum suction height of the diaphragm pump (41) is, for example, 2.5 meters. The housing (46) of the diaphragm pump (41) is made of aluminum. In the exemplary embodiment, the diaphragms and the seats of the check valves are made of nitrile butadiene rubber (NBR). The balls of the check valves are made, for example, of polytetraflourethylene (PTFE).

In the exemplary embodiment, the tank container (21) is filled with a propylene glycol solution, for example 1,2 propanediol. Such solution can be used, for example, as a food supplement. It is also conceivable to fill the tank container (21) with water or another liquid. In the illustration in FIG. 1, a suction tube (51) is inserted in the extraction opening (23) of the tank container (21). Such suction tube (51) projects into the solution. A suction line (52) is connected to the suction tube (51) and opens into the inlet connection (44) of the diaphragm pump (41). Such suction line (52) is a feed line (52) of the diaphragm pump (41).

The compressed air reservoir (31) is connected to the compressed air connection (43) of the diaphragm pump (41) by means of a pressure line (61). A control element (62) of the diaphragm pump (41) is arranged in such pressure line (61). Such control element (62) is an settable pressure-reducing valve (62). For example, by means of the pressure-reducing valve (62), the outlet pressure of the compressed air reservoir (31) is reduced to a pressure between 0.5 bar and 1 bar. In the exemplary embodiment, the pressure-reducing valve (62) is designed with an integrated shut-off valve (64). However, it is also conceivable to use a shut-off valve (64) separate from the pressure-reducing valve (62) in the pressure line (61). Such shut-off valve (64) can be used upstream or downstream of the pressure-reducing valve (62) in the direction of flow (63). The shut-off valve (64) then has an open and a closed rest position. For example, it is designed as a 2/2-way directional control valve with manual actuation.

A dispensing unit (71) is connected to the outlet connection (45) of the diaphragm pump (41). The dispensing unit (71) comprises a hose (72), a gripping part (73) and a lance (74). In the exemplary embodiment, the hose (72) has a length of three meters. Such hose (72) can also be designed to be longer or shorter. The hose (72) ends in the gripping part (73). Such gripping part (73) has, for example, an integrated, manually actuated release valve (75). For example, the release valve (75) can be switched by means of the hand of the operator holding the gripping part (73). In the exemplary embodiment, the release valve (75) is a manually actuated 2/2-way valve with a spring return to the blocking position. When the release valve (75) is released, the media flow is thus interrupted and blocked.

The release valve (75) can also have a pulse counter that blocks the release valve (75) after a predetermined, for example settable, number of pressure surges of the diaphragm pump (41). The use of a timer is also conceivable. When using a pulse counter, it can comprise an acceleration sensor connected to a counting mechanism. When the, for example pushbutton-type, release valve (75) is actuated manually, the media flow is enabled. In this process, for example, a circuit coupled to the counting mechanism can be switched on, which energizes an electromagnet arranged on the release valve. The release valve (75) is held in the open position by means of the electromagnet until the circuit is switched off by means of the counting mechanism or due to the timer. The release valve (75) is then closed again under spring load.

The release valve (75) can also be mechanically latched in the open position until the latch is opened due to a signal from the counting mechanism or the passage of time. In this case as well, the release valve (75) is switched to the closed position, for example under spring load, after the operating signal of the counting mechanism or the timer has ceased.

The release of a mechanical latching of the release valve (75) in the flow position can also be effected mechanically. For example, when the release valve (75) is actuated, four individual latches can be actuated in succession like a ratchet. Each pulse of the diaphragm pump (41) then releases a latch until, after all latches have been released, the release valve (75) moves to the closed initial position.

A, for example replaceable, lance (74) is fastened to the gripping part (73). The lance (74) is designed in the form of a tube and has an at least approximately constant cross-section along its length. For example, the cross-section of the open dispensing tube (76) of the lance (74) corresponds to such cross-section. In the region adjacent to the gripping part (73), the lance (74) is designed to be curved. The lance (74) is made of a reinforced material, for example, a reinforced plastic. The use of a lance (74) made of an austenitic steel, for example, is also conceivable.

In order to prepare for use of the device (10), a compressed air line (35) is connected to the compressed air container (31) to fill the compressed air container (31). After completion of the filling process, the compressed air line (35) can be separated from the compressed air reservoir (31) after blocking the stopcock (33). The tank container (21) is filled with the aforementioned solution, for example. The operator can now move the device (10) by means of the hand truck (11), for example to a pasture or to a stable position.

Here, the shut-off valve (64) of the pressure-reducing valve (62) is opened. The pressure at the pressure-reducing valve (62) can be set to the aforementioned pressure, for example. For example, the aforementioned liquid is more viscous when cold than when warm, so that the pressure-reducing valve (62) can be set to a lower pressure when the liquid is warm than when it is cold. If necessary, the adjustment of the pressure to the temperature and/or to the instantaneous viscosity of the liquid and/or to the outside temperature can be automated. When pressure is applied, the diaphragm pump (41) starts. In the diaphragm pump (41), the compressed air is moved back and forth between the pressure chambers. However, since the release valve (75) is initially closed, the diaphragm pump (41) cannot convey.

For example, with a cow, energy supply can be impaired, due to reduced liquid intake during the calving period. The operator moves the hand truck (11) with the device (10) to such a cow, for example. Here, he introduces the lance (74) orally. In this process, the device (10) is not actuated. The operator can thus concentrate fully on his work on the animal. After inserting the lance (74), the operator actuates the release valve (75). The dispensing unit (71) is released. The diaphragm pump (41) now conveys the liquid from the tank container (21) in the conveying direction (47) to the dispensing unit (71). In this process, the liquid is conveyed intermittently from the diaphragm pump (41) into the lance (74). The conveying pressure of the conveyed liquid corresponds to the pressure of the working medium set at the pressure-reducing valve (62). The liquid flows out of the lance (74) into the cow's rumen at low pressure. For example, the aforementioned volume of liquid is discharged with each double cycle of the diaphragm pump (41). The operator can continue to calm the animal. The cow is not unsettled by movements of the operator. For example, after four double cycles of the diaphragm pump (41), the operator releases the release valve (75). The release valve (75) returns, for example in a spring-loaded manner, to its closed initial position. In the case of a device (10) with a pulse counter, for example, the release valve (75) is automatically blocked after a predetermined number of pulses following manual release. In the case of a release valve (75) with a timer, the valve is blocked after the expiration of a time interval corresponding to a predetermined number of pump cycles. The conveying flow is interrupted. For example, the cow has now received the intended volume of liquid.

After interrupting the conveying flow of the liquid, it is not necessary to stop the diaphragm pump (41). The structure of the diaphragm pump (41) prevents damage to the diaphragm pump (41) when the media conveying flow is blocked. The operator can still remain with the animal. Now the operator can remove the lance (74) again and move the device (10) to a next cow by means of the hand truck (11). After completing the activity, the operator locks the shut-off valve (64) on the pressure-reducing valve (62). The diaphragm pump (41) stops immediately. The use of an electrically operated diaphragm pump (41) is analogous.

The device (10) can also be used to extract liquid from the rumen of a cow, for example. In this process, a tubular suction lance is connected to the feed line (52) instead of the tank container (21). A rumen sampling probe, for example, can be connected to this. The dispensing unit (71) can, for example, have a lance (74) that is designed to be short. The gripping part (73) and the release valve (75) are designed, for example, as described above. The release valve (75) can also be designed as a stopcock spaced from the gripping part (73). In this case as well, the number of audible pump cycles of the diaphragm pump (41) correlates with the volume of liquid removed. The operator can thus concentrate well on the cow during work.

The device (10) can also be applied to provide liquid for mixing limited amounts of mortar, concrete, plaster, etc. In this process, for example, the tank container (21) is filled with water. The device (10), which can be moved by means of the hand truck (11), can also be used outside of driveways. During operation, the water is fed to the dry mortar, for example, by means of the diaphragm pump (41) and the dispensing unit (71). The dosage takes place, for example, as described above. Other applications are also conceivable.

The individual exemplary embodiments mentioned can also be combined with one another.

### LIST OF REFERENCE SIGNS

10 Device
11 Transport carriage, hand truck
12 Wheels
13 Base mounting plate
14 Gripping linkage
15 Gripping pieces
16 Front side of (11)
17 Support plate
18 Rear side
19 Pump plate
21 Tank container, canister
22 Closure
23 Extraction opening
31 Energy reservoir, compressed air reservoir, compressed air container
32 Threaded connections
33 Stopcock
34 Quick coupling
35 Compressed air line
41 Conveying device, diaphragm pump, double diaphragm pump
42 Foot plates
43 Compressed air connection
44 Inlet connection
45 Outlet connection
46 Housing
47 Conveying direction
51 Suction tube
52 Suction line, feed line
61 Pressure line
62 Pressure-reducing valve, control element
63 Direction of flow
64 Shut-off valve
71 Dispensing unit, output unit
72 Hose
73 Gripping part
74 Lance
75 Release valve
76 Discharge of (74), dispensing tube

1. A device (10) for pulsed liquid dispensing, comprising:
a feed line (52);
a dispensing unit (71); and
a conveying device (41),
wherein the dispensing unit (71) has a rigid lance (74) with a dispensing tube (76),
wherein the feed line (52) is connected to an inlet connection (44) of the conveying device (41),
wherein an outlet connection (45) of the conveying device (41) is connected to the dispensing unit (71),
wherein the dispensing unit (71) comprises a gripping part (73) and a manually actuated release valve (75), and
wherein the conveying device (41) is a diaphragm pump (41), so that, once the release valve (75) is open, a number of pump cycles of the diaphragm pump (41) correlates with a volume of dispensed liquid.

2. The device (10) according to claim 1,
wherein the device (10) comprises an energy reservoir (31) for driving the diaphragm pump (41).

3. The device (10) according to claim 2,
wherein the energy reservoir (31) is a compressed air container (31).

4. The device (10) according to claim 1,
wherein the diaphragm pump (41) is a double diaphragm pump (41).

5. The device (10) according to claim 1,
wherein the feed line (52) is designed as a suction line (52).

6. The device (10) according to claim 1,
further comprising a tank container (21) connected to the feed line (52).

7. The device (10) according to claim 1,
further comprising a transport carriage (11).

8. The device (10) according to claim 1,
wherein a control element (62) is connected upstream of the diaphragm pump (41).

9. The device (10) according to claim 1,
further comprising a pump pulse-controlled or time-controlled reset device of the release valve (75).

10. (canceled)

11. A method, comprising:
providing a device (10) for pulsed liquid dispensing, including
a diaphragm pump (41),
a feed line (52) connected to an inlet connection (44) of the conveying device (41),
a dispensing unit (71) having
a rigid lance (74) with a dispensing tube (76),
a gripping part (73), and
a manually actuated release valve (75),
the dispensing unit (71) being connected to an outlet connection (45) of the conveying device (41),
wherein, once the release valve (75) is open, a number of pump cycles of the diaphragm pump (41) correlates with a volume of dispensed liquid;
connecting the diaphragm pump (41) to an energy source or to an energy reservoir (31);
opening the release valve (75) while the diaphragm pump (41) is running; and
closing the release valve (75) after completion of a predetermined number of pump cycles of the diaphragm pump (41).
